(19) United States
(12) Patent Application Publication
(10) Pub. No.: US 2020/0257413 A1
(43) Pub. Date: Aug. 13, 2020

(54) VEHICULAR AVNT SYSTEM, METHOD OF CONTROLLING THE SAME AND VEHICLE INCLUDING THE SAME

(71) Applicants: HYUNDAI MOTOR COMPANY, Seoul (KR); KIA MOTORS CORPORATION, Seoul (KR)

(72) Inventor: Sang Yong Jung, Suwon-si (KR)

(21) Appl. No.: 16/435,975

(22) Filed: Jun. 10, 2019

(30) Foreign Application Priority Data
Feb. 8, 2019 (KR) 10-2019-0014988

(51) Int. Cl. G06F 3/0482; G06F 3/0484

(52) U.S. Cl. CPC G06F 3/0482; G06F 3/04847

(57) ABSTRACT

A vehicular audio video navigation telematics (AVNT) system includes: an input device configured to receive user input for executing a plurality of AVNT function menus; a storage device configured to index and store the AVNT function menus, a display configured to display a home screen menu including the AVNT function menus; and a controller configured to control the storage device and the display. The controller collects an execution count of each of the AVNT function menus based on the user input, indexes and stores the AVNT function menus in the storage device based on the collected execution count of each of the AVNT function menus, resets the home screen menu based on high-order menus of stored indices, and controls the display to display the reset home screen menu.

This application claims the benefit of Korean Patent Application No. 10-2019-0014988, filed on Feb. 8, 2019 in the Korean Intellectual Property Office, which is hereby incorporated by reference as if fully set forth herein.

### TECHNICAL FIELD

The present disclosure relates to a vehicular audio video navigation telematics (AVNT) system, and more particularly, to a vehicular AVNT system capable of actively configuring AVNT menus based on AVNT function execution information of a user to provide a user with various opportunities to utilize functions, a method of controlling the same, and a vehicle including the same.

### BACKGROUND

In general, a vehicular audio video navigation telematics (AVNT) system provides various conveniences to vehicle passengers, by integrating various electronic devices such as an audio device, a video device, a navigation device and a telematics device mounted in a vehicle.

The vehicular AVNT system has a plurality of electronic devices integrated therein and includes various functions and menus. However, many drivers are not aware of all of the AVNT functions and may use only some of the functions.

In recent years, as the AVNT functions for an AVNT device have been further diversified, users such as drivers are not aware of new functions of the AVNT device.

Therefore, the AVNT device is not utilized fully, and many users are not fully enjoying various conveniences of the conventional AVNT device.

Accordingly, there is a need for development of a vehicular AVNT system capable of actively configuring AVNT menus based on AVNT function execution information of a user to provide the user with various opportunities to utilize functions.

### SUMMARY

The present disclosure is directed to a vehicular audio video navigation telematics (AVNT) system, a method of controlling the same, and a vehicle including the same that substantially obviate one or more problems due to limitations and disadvantages of the related art.

An object of the present disclosure is to provide a vehicular AVNT system capable of providing a user with various opportunities to utilize various AVNT function menus, by indexing AVNT function menus based on the execution counts of ANVT function menus and resetting a home screen menu based on menus each having a small execution count, a method of controlling the same, and a vehicle including the same.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to an exemplary embodiment of the present disclosure, a vehicular audio video navigation telematics (AVNT) system includes: an input device configured to receive user input for executing a plurality of AVNT function menus; a storage device configured to index and store the plurality of AVNT function menus; a display configured to display a home screen menu including the plurality of AVNT function menus; and a controller configured to control the storage device and the display. The controller collects an execution count of each of the plurality of AVNT function menus based on the user input, indexes and stores the plurality of AVNT function menus in the storage device based on the collected execution count of each of the plurality of AVNT function menus, resets the home screen menu based on high-order menus of stored indices, and controls the display to display the reset home screen menu.

The vehicular AVNT system may further include a communication device communicating with an external server, and the controller may collect the execution count of each of the plurality of AVNT function menus based on the user input, control the communication device to transmit information on the collected execution count of each of the plurality of AVNT function menus to the external server, reset the home screen menu based on received index setting values when the index setting values of the home screen menu are received from the external server through the communication device, and control the display to display the reset home screen menu.

The vehicular AVNT system may further include a communication device communicating with a user terminal and, when index setting values of the home screen menu are received from the user terminal through the communication device, the controller may reset the home screen menu based on the received index setting values and control the display to display the reset home screen menu.

In another exemplary embodiment of the present disclosure, a method of controlling a vehicular audio video navigation telematics (AVNT) system for displaying a home screen menu including a plurality of AVNT function menus includes: collecting an execution count of each of the plurality of AVNT function menus based on user input; indexing and storing the plurality of AVNT function menus based on the collected execution count of each of the plurality of AVNT function menus; resetting the home screen menu based on high-order menus of stored indices, and displaying the reset home screen menu.

In another exemplary embodiment of the present disclosure, a method of controlling a vehicular audio video navigation telematics (AVNT) system configured to communicate with an external server and to display a home screen menu including a plurality of AVNT function menus includes: collecting an execution count of each of the plurality of AVNT function menus based on user input; transmitting information on the collected execution count of each of the plurality of AVNT function menus to the external server; receiving index setting values of the home screen menu from the external server; resetting the home screen menu based on the received index setting values; and displaying the reset home screen menu.

In another exemplary embodiment of the present disclosure, a method of controlling a vehicular audio video navigation telematics (AVNT) system configured to communicate with a user terminal and to display a home screen menu including a plurality of AVNT function menus includes; receiving index setting values of the home screen menu from the user terminal; resetting the home screen menu based on the received index setting values; and displaying the reset home screen menu.

In another exemplary embodiment of the present disclosure, a computer-readable recording medium having recorded thereon a method of controlling a vehicular AVNT system may perform a process provided in the method of controlling the vehicular AVNT system.

In another exemplary embodiment of the present disclosure, a vehicle includes: a communication device configured to communicate with an external server or a user terminal; and an audio video navigation telematics (AVNT) system configured to display a home screen menu including a plurality of AVNT function menus. The AVNT system collects an execution count of each of the plurality of AVNT function menus based on user input, indexes and stores the plurality of AVNT function menus based on the collected execution count of each of the plurality of AVNT function menus, resets the home screen menu based on high-order menus of stored indices, and displays the reset home screen menu.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate exemplary embodiment(s) of the disclosure and together with the description serve to explain the principle of the disclosure. In the drawings:

FIG. 1 is a block diagram showing a vehicular AVNT system according to an exemplary embodiment of the present disclosure;

FIG. 2 is a view illustrating a display for displaying a home screen menu including a plurality of AVNT function menus;

FIG. 3 is a flowchart illustrating a method of controlling a vehicular AVNT system according to an exemplary embodiment of the present disclosure;

FIG. 4 is a flowchart illustrating a method of controlling a vehicular AVNT system according to another exemplary embodiment of the present disclosure; and

FIG. 5 is a flowchart illustrating a method of controlling a vehicular AVNT system according to another exemplary embodiment of the present disclosure.

### DETAILED DESCRIPTION

Hereinafter, exemplary embodiments of the present disclosure will be described in detail with reference to the accompanying drawings so as to be easily implemented by those skilled in the art. However, the present disclosure may be variously implemented and is not limited to the embodiments described herein. In the drawings, in order to clearly describe the present disclosure, portions which are not related to the description of the present disclosure will be omitted and similar portions are denoted by similar reference numerals throughout the specification.

In the entire specification, when a certain portion “includes” a certain component, this indicates that other components are not excluded, but may be further included unless specially described. The terms “unit,” “device,” “-or/er,” and “module” described in the specification indicate a unit for processing at least one function or operation, which may be implemented by hardware, software or a combination thereof.

Throughout the specification, when a certain portion “includes” a certain component, this indicates that the other components are not excluded, but may be further included unless specially described. The same reference numbers will be used throughout the drawings to refer to the same or like parts.

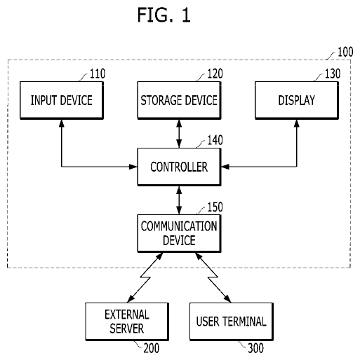

Hereinafter, a vehicular AVNT system, a method of controlling the same and a vehicle including the same, which are applicable to the exemplary embodiments of the present disclosure, will be described in detail with reference to FIGS. 1 to 5.

Here, the vehicular AVNT system 100 according to the present disclosure may also be referred to as a head unit (H/U).

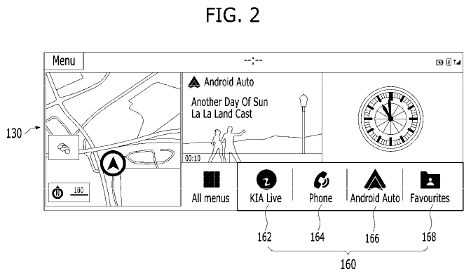

FIG. 1 is a block diagram showing a vehicular AVNT system according to an exemplary embodiment of the present disclosure, and FIG. 2 is a view illustrating a display for displaying a home screen menu including a plurality of AVNT function menus;

As shown in FIGS. 1 and 2, the vehicular AVNT system 100 according to the present disclosure may include an input device 110 for receiving user input for executing a plurality of AVN function menus, a storage device 120 for indexing and storing AVNT function menus, a display 130 for displaying a home screen menu including a plurality of AVNT function menus and a controller 140 for controlling the storage device 120 and the display 130.

Here, the controller 140 may collect the execution count of each AVNT function menu based on user input, index and store the AVNT function menus based on the collected execution count of each AVNT function menu, reset a home screen menu 160 based on high-order menus of stored indices, and control the display 130 to display the reset home screen menu 160.

For example, the plurality of AVNT function menus may include at least one of a telephone menu, a driving information menu, a phone projection menu, a radio menu, a media menu, a USB video menu, a map menu, a navigation menu, a setup menu, a favorite menu, a voice memo menu, or a DMB menu, without being limited thereto.

In addition, when the AVNT function menus are indexed and stored in the storage device 120, the controller 140 may accumulate the execution count of each AVNT function menu based on the collected execution count of each AVNT function menu and index and store the AVNT function menus in the storage device 120 according to the order of accumulated execution counts.

Here, when the AVNT function menus are indexed and stored in the storage device 120, the controller 140 may index and store the AVNT function menus in ascending order of accumulated execution counts.

Subsequently, when the AVNT function menus are indexed and stored in the storage device 120, the controller 140 may store the AVNT function menus when the vehicle is turned off.

Next, when the home screen menu 160 is reset, the controller 140 may determine the number of high-order menus to be selected from the stored indices, select high-order menus from the indices according to the determined number of high-order menus, and reset the home screen menu 160 using the selected high-order menus.

Here, when the number of high-order menus is determined, the controller 140 may determine the number of high-order menus according to the number of AVNT function menus of the home screen menu 160 capable of being displayed on the screen of the display 130.

When the home screen menu 160 is reset, the controller 140 may reset the home screen menu 160 at the time of first booting after a predetermined cycle.

For example, the predetermined cycle may be any one of a cycle set on a daily basis, a cycle set on a weekly basis or a cycle set on a monthly basis, without being limited thereto.

In addition, when the display 130 is controlled to display the reset home screen menu 160, the controller 140 may control the display 130 to display a reset notification message if the home screen menu 160 is reset.

Next, when the display 130 is controlled to display the reset home screen menu 160, if user input of selecting an AVNT function menu of the reset home screen menu 160 is received, the controller 140 may control the display 130 to display a shortcut link for providing a web manual corresponding to the selected AVNT function menu.

Here, the user input of selecting the AVNT function menu of the reset home screen menu 160 may be user input of touching the AVNT function menu of the home screen menu 160 for a predetermined time or more, without being limited thereto.

In some cases, the controller 140 may control the display 130 to display a shortcut link for providing a web manual corresponding to the selected AVNT function menu when the vehicle is stopped.

For example, the shortcut link may be a QR code, without being limited thereto.

In addition, the web manual may be provided as an HTML file through a web server, without being limited thereto.

In other cases, the controller 140 may audibly provide a web manual summary corresponding to the selected AVNT function menu through text-to-speech (TTS) when the vehicle is traveling.

The AVNT system 100 of the present disclosure may directly index the AVNT function menus based on the execution count of each of AVNT function menu and reset the home screen menu 160 based on menus each having a small execution count.

That is, in the present disclosure, the execution count of each AVNT function menu button used by the user may be collected and the information on the collected execution count may be stored in the storage device as a database (DB) when the vehicle is turned off.

For example, the indices of the AVNT function menus may be telephone (1)/driving information (2)/phone projection (3)/radio (4)/media (5)/USB video (6)/map (7)/navigation (8)/setup (8)/favorite (10)/voice memo (11)/DMB (12).

In addition, the system 100 may index and store the AVNT function menus in ascending order of execution counts of the AVNT function menu buttons based on the DB stored in the storage device on a weekly basis.

Subsequently, the system 100 may select four high-order menus, store index setting values of the screen menu 160 and reset the home screen menu 160 at the time of booting after a predetermined cycle.

Next, the system 100 may notify the user of changes through popup notification after booting is completed.

At this time, a function for reading popup notification text through TTS may be provided.

In addition, when the user presses a menu button for a long time, a corresponding function link shortcut may be provided through a web manual in order to guide a corresponding function.

Here, the web manual may be provided as an HTML file for a terminal manual through a web server and the system 100 may be provided with a QR code to be linked to the web server.

The AVNT system 100 of the present disclosure may further include a communication device 150 communicating with an external server 200.

Here, the controller 140 of the system 100 may collect the execution count of each AVNT function menu based on user input, control the communication device 150 to transmit information on the collected execution count of each AVNT function menu to the external server 200, reset the home screen menu 160 based on index setting values received when the index setting values of the home screen menu 160 are received from the external server 200 through the communication device 150, and control the display 130 to display the reset home screen menu 160.

At this time, when the information on the collected execution count of each AVNT function menu is transmitted to the external server 200, the controller 140 may transmit the information when the vehicle is turned off.

In addition, when the home screen menu 160 is reset, if the mode state of the system is a sleep mode state, the controller 140 may reset the home screen menu 160 based on the received index setting values after the system is switched to a wakeup mode state.

In some cases, when the home screen menu 160 is reset, if the mode state of the system is a normal mode state, the controller 140 may reset the home screen menu 160 based on the received index setting values at the time of first booting after a predetermined cycle.

Here, the predetermined cycle may be any one of a cycle set on a daily basis, a cycle set on a weekly basis or a cycle set on a monthly basis, without being limited thereto.

In addition, when the information on the execution count of each AVNT function menu is received, the external server 200 may index and store AVNT function menus based on the received execution count of each AVNT function menu, select high-order menus of stored indices to generate the index setting values of the home screen menu 160, and transmit the generated index setting values to the communication device 150 of the system 100.

Here, when the AVNT function menus are indexed and stored, the external server 200 may store the AVNT function menus based on a vehicle identification number (VIN).

In addition, when the AVNT function menus are indexed and stored, the external server 200 may accumulate the execution count of each AVNT function menu based on the execution counts of the received AVNT function menus, and index and store the AVNT function menus according to the order of accumulated execution counts.

When the AVNT function menus are indexed and stored in the storage device 120, the external server 200 may index and store the AVNT function menus in ascending order of accumulated execution counts.

Subsequently, when the index setting values of the home screen menu 160 are generated, the external server 200 may determine the number of high-order menus to be selected from the stored indices, select the high-order menus from the indices according to the determined number of high-order menus, and generate the index setting values of the home screen menu 160 based on the selected high-order menus.

Here, when the number of high-order menus is determined, the external server 200 may determine the number of high-order menus according to the number of AVNT function menus of the home screen menu 160 capable of being displayed on the screen of the display 130.

In addition, when the generated index setting values are transmitted to the communication device 150 of the system 100, the external server 200 may transmit the generated index setting values according to the predetermined cycle.

Here, the predetermined cycle may be any one of a cycle set on a daily basis, a cycle set on a weekly basis or a cycle set on a monthly basis, without being limited thereto.

The AVNT system 100 according to the present disclosure may interwork with the external server 200, and reset the home screen menu 160 based on the index setting values of the home screen menu 160 received from the external server 200, when the index setting values of the home screen menu 160 are received from the external server 200.

That is, in the present disclosure, the execution count of each AVNT function menu used by the user may be collected and information on the collected execution count may be transmitted to the external server 200 on a weekly basis.

In addition, the external server 200 may index and store the AVNT function menus in ascending order of execution counts of the AVNT function menu buttons.

For example, the indices of the AVNT function menus may be telephone (1)/driving information (2)/phone projection (3)/radio (4)/media (5)/USB video (6)/map (7)/navigation (8)/setup (8)/favorite (10)/voice memo (11)/DMB (12).

Subsequently, the external server 200 may select four high-order menus in ascending order of execution counts while the collected execution count of each AVNT function menu is stored as a DB based on the VIN information.

Next, the external server 200 may transmit the selected four menus to the system 100.

When the system 100 is in a sleep mode, the system 100 may reset the home screen menu 160 after the wakeup mode.

For example, if the index setting values of the home screen menu 160 received from the external server 200 are 2, 4, 5 and 6, the home screen menu 160 may be reset to “driving information/radio/media/USB video” instead of the existing “KIA Live (162)/Phone (164)/Android Auto (166)/Favourites (168)”.

In addition, when the system 100 operates in the normal mode, the system 100 may store the index setting values of the home screen menu 160 received from the external server 200 and reset the home screen menu 160 at the time of booting after a certain cycle.

Next, the system 100 may notify the user of changes through popup notification after booting is completed.

At this time, a function for reading popup notification text through TTS may be provided.

In addition, when the user presses a menu button for a long time, a corresponding function link shortcut may be provided as a web manual in order to guide a corresponding function.

Here, the web manual may be provided as an HTML file for a terminal manual through a web server and the system 100 may be provided with a QR code to be linked to the web server.

The AVNT system 100 of the present disclosure may further include a communication device 150 communicating with a user terminal 300.

When the index setting values of the home screen menu 160 are received from the user terminal 300, the controller 140 of the system 100 may reset the home screen menu 160 based on the received index setting values and control the display 130 to display the reset home screen menu 160.

In addition, when the home screen menu 160 is reset, if the mode state of the system is a sleep mode state, the controller 140 may reset the home screen menu 160 based on the received index setting values after the system is switched to a wakeup mode state.

In some cases, when the home screen menu 160 is reset, if the mode state of the system is a normal mode state, the controller 140 may reset the home screen menu 160 based on the received index setting values at the time of first booting after a predetermined cycle.

Here, the predetermined cycle may be any one of a cycle set on a daily basis, a cycle set on a weekly basis or a cycle set on a monthly basis, without being limited thereto.

In addition, the user terminal 300 may generate index setting values of the home screen menu 160 based on user input received from a BlueLink Phone App and transmit the generated index setting values to the communication device 150 of the system 100.

When the index setting values of the home screen menu 160 are received through the phone app of the user terminal 300, the AVNT system 100 of the present disclosure may reset the home screen menu 160 based on the received index setting values.

That is, in the present disclosure, the user may set and store up to four desired menus of the home screen menu 160 in the BlueLink Phone App of the user terminal 300 and then transmit the set home screen menus 160 to the system 100.

When the system 100 is in a sleep mode, the system 100 may reset the home screen menu 160 after the wakeup mode.

For example, if the index setting values of the home screen menu 160 received from the user terminal 300 are 2, 4, 5 and 6, the home screen menu 160 may be reset to “driving information/radio/media/USB video” instead of the existing “KIA Live (162)/Phone (164)/Android Auto (166)/Favourites (168)”.

In addition, when the system 100 operates in the normal mode, the system 100 may store the index setting values of the home screen menu 160 received from the user terminal 300 and reset the home screen menu 160 at the time of booting after a certain cycle.

Next, the system 100 may notify the user of changes through popup notification after booting is completed.

At this time, a function for reading popup notification text through TTS may be provided.

In addition, when the user presses a menu button for a long time, a corresponding function link shortcut may be provided as a web manual in order to guide a corresponding function.

Here, the web manual may be provided as an HTML file for a terminal manual through a web server and the system 100 may be provided with a QR code to be linked to the web server.

In the present disclosure, the AVNT function menus may be indexed based on the execution count of each AVNT function menu and the home screen menu may be reset based on the menus each having a small execution count, thereby providing the user with opportunities to utilize various AVNT function menus.

The present disclosure may actively provide various AVNT functions to the user, thereby enabling the user to use more AVNT functions and enabling the user to experience improved merchantability of the AVNT functions.

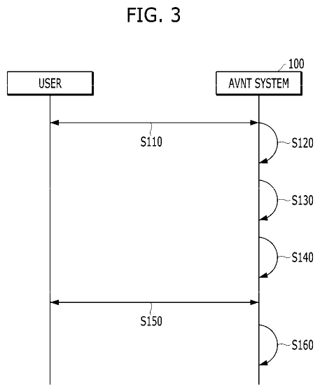

FIG. 3 is a flowchart illustrating a method of controlling a vehicular AVNT system according to an exemplary embodiment of the present disclosure.

As shown in FIG. 3, the AVNT system 100 of the present disclosure may directly index the AVNT function menus based on the execution count of each AVNT function menu and reset the home screen menu based on menus each having a small execution count.

For example, the system 100 may receive user input of executing a plurality of the AVNT function menus (S110).

In addition, the system 100 may collect the execution count of each AVNT function menu based on user input (S120).

Subsequently, the system 100 may index and store the AVNT function menus based on the collected execution count of each AVNT function menu (S130).

Here, the controller 140 may accumulate the execution count of each AVNT function menu based on the collected execution count of each AVNT function menu and index and store the AVNT function menus according to the order of accumulated execution counts.

For example, the system 100 may index and store the AVNT function menus in ascending order of accumulated execution counts when the vehicle is turned off.

Next, the system 100 may reset the home screen menu based on the high-order menus of the stored indices and display the reset home screen menu (S140).

Here, the system 100 may determine the number of high-order menus to be selected from the stored indices, select high-order menus from the indices according to the determined number of high-order menus, and reset the home screen menu 160 using the selected high-order menus.

For example, the system 100 may determine the number of high-order menus according to the number of AVNT function menus capable of being displayed in the home screen menu 160.

The controller 140 may reset the home screen menu at the time of first booting after a predetermined cycle.

For example, the predetermined cycle may be any one of a cycle set on a daily basis, a cycle set on a weekly basis or a cycle set on a monthly basis, without being limited thereto.

In addition, when the home screen menu is reset, the system 100 may output a reset notification message, perform TTS and display a web link provision guide for function menu description (S150).

Subsequently, when user input of selecting an AVNT function menu of the reset home screen menu is received, the system 100 may display a shortcut link for providing a web manual corresponding to the selected AVNT function menu (S160).

Here, the user input of selecting the AVNT function menu of the reset home screen menu may be user input of touching the AVNT function menu of the home screen menu for a predetermined time or more, without being limited thereto.

In some cases, the system 100 may control the display 130 to display a shortcut link for providing a web manual corresponding to the selected AVNT function menu when the vehicle is stopped.

For example, the shortcut link may be a QR code, and the web manual may be provided as an HTML file through a web server, without being limited thereto.

In other cases, the system 100 may audibly provide a web manual summary corresponding to the selected AVNT function menu through text-to-speech (TTS) when the vehicle is traveling.

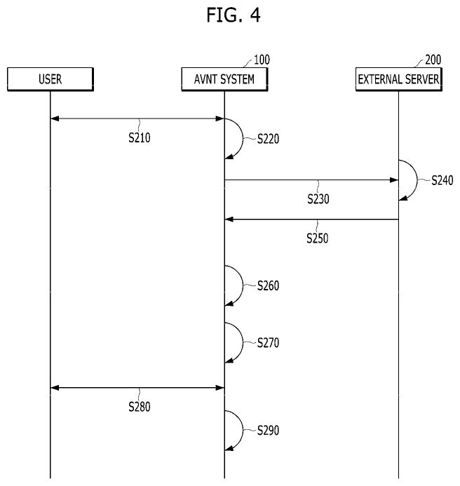

FIG. 4 is a flowchart illustrating a method of controlling a vehicular AVNT system according to another exemplary embodiment of the present disclosure.

As shown in FIG. 4, the AVNT system 100 according to the present disclosure may interwork with the external server 200, and reset the home screen menu based on the index setting values of the home screen menu received from the external server 200 when the index setting values of the home screen menu are received from the external server 200.

First, the system 100 may receive user input of executing a plurality of AVNT function menus (S210).

In addition, the system 100 may collect the execution count of each AVNT function menu based on user input (S220).

Subsequently, the system 100 may transmit the information on the collected execution count of each AVNT function menu to the external server 200 (S230).

Here, the system 100 may transmit the information on the collected execution count of each AVNT function menu to the external server 200 when the vehicle is turned off.

Next, when the information on the execution count of each AVNT function menu is received, the external server 200 may index and store the AVNT function menus based on the received execution count of each AVNT function menu, select high-order menus of the stored indices, and generate index setting values of the home screen menu (S240).

Here, when the AVNT function menus are indexed and stored, the external server 200 may store the AVNT function menus based on a vehicle identification number (VIN).

In addition, when the AVNT function menus are indexed and stored, the external server 200 may accumulate the execution count of each AVNT function menu based on the execution counts of the received AVNT function menus, and index and store the AVNT function menus in the order of the accumulated execution counts.

When the AVNT function menus are indexed and stored, the external server 200 may index and store the AVNT function menus in ascending order of accumulated execution counts.

In addition, when the index setting values of the home screen menu are generated, the external server 200 may perform a step of determining the number of high-order menus to be selected from the stored indices, a step of selecting the high-order menus from the indices according to the determined number of high-order menus, and a step of generating the index setting values of the home screen menu 160 based on the selected high-order menus.

Here, when the number of high-order menus is determined, the external server 200 may determine the number of high-order menus according to the number of AVNT function menus capable of being displayed in the home screen menu.

Subsequently, the external server 200 may transmit the generated index setting values to the system 100 (S250).

Here, when the generated index setting values are transmitted, the external server 200 may transmit the generated index setting values according to a predetermined cycle.

Here, the predetermined cycle may be any one of a cycle set on a daily basis, a cycle set on a weekly basis or a cycle set on a monthly basis, without being limited thereto.

When the index setting values of the home screen menu are received from the external server 200, the system 100 may reset the home screen menu based on the received index setting values (S260, S270).

Here, if the mode state of the system is a sleep mode state, the system may reset the home screen menu based on the received index setting values after the system is switched to a wakeup mode state (S260).

In addition, if the mode state of the system is a normal mode state, the home screen menu may be reset based on the received index setting values at the time of first booting after a predetermined cycle (S270).

Here, the predetermined cycle may be any one of a cycle set on a daily basis, a cycle set on a weekly basis or a cycle set on a monthly basis, without being limited thereto.

In addition, when the home screen menu is reset, the system 100 may output a reset notification message, perform TTS, and display a web link provision guide for function menu description (S280).

Subsequently, when user input of selecting an AVNT function menu of the reset home screen menu is received, the system 100 may display a shortcut link for providing a web manual corresponding to the selected AVNT function menu (S290).

Here, the user input of selecting the AVNT function menu of the reset home screen menu may be user input of touching the AVNT function menu of the home screen menu for a predetermined time or more, without being limited thereto.

In some cases, the system 100 may display a shortcut link for providing a web manual corresponding to the selected AVNT function menu when the vehicle is stopped.

For example, the shortcut link may be a QR code, and the web manual may be provided as an HTML file through a web server, without being limited thereto.

In other cases, the system 100 may audibly provide a web manual summary corresponding to the selected AVNT function menu through text-to-speech (TTS) when the vehicle is traveling.

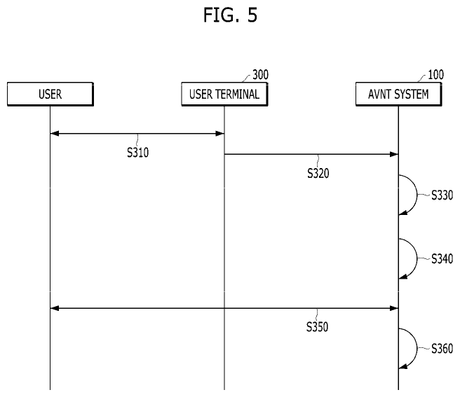

FIG. 5 is a flowchart illustrating a method of controlling a vehicular AVNT system according to another exemplary embodiment of the present disclosure.

As shown in FIG. 5, the AVNT system 100 according to the present disclosure may communicate with the user termina1300 and may reset the home screen menu based on the index setting values of the home screen menu when the index setting values of the home screen menu are received from the user terminal 300.

First, the user terminal 300 may generate the index setting values of the home screen menu based on user input received through BlueLink Phone App (S310).

In addition, the user terminal 300 may transmit the generated index setting values to the system 100 (S320).

Subsequently, when the index setting values of the home screen menu are received from the user terminal 300, the system 100 may reset the home screen menu based on the received index setting values (S330 and S340).

Here, if the mode state of the system is a sleep mode state, the system may reset the home screen menu based on the received index setting values after the system is switched to a wakeup mode state (S330).

In addition, if the mode state of the system is a normal mode state, the home screen menu may be reset based on the received index setting values at the time of first booting after a predetermined cycle (S340).

Here, the predetermined cycle may be any one of a cycle set on a daily basis, a cycle set on a weekly basis or a cycle set on a monthly basis, without being limited thereto.

In addition, when the home screen menu is reset, the system 100 may output a reset notification message, perform TTS and display a web link provision guide for function menu description (S350).

Subsequently, when user input of selecting an AVNT function menu of the reset home screen menu is received, the system 100 may display a shortcut link for providing a web manual corresponding to the selected AVNT function menu (S360).

Here, the user input of selecting the AVNT function menu of the reset home screen menu may be user input of touching the AVNT function menu of the home screen menu for a predetermined time or more, without being limited thereto.

In some cases, the system 100 may display a shortcut link for providing a web manual corresponding to the selected AVNT function menu when the vehicle is stopped.

For example, the shortcut link may be a QR code, and the web manual may be provided as an HTML file through a web server, without being limited thereto.

In other cases, the system 100 may audibly provide a web manual summary corresponding to the selected AVNT function menu through text-to-speech (TTS) when the vehicle is traveling.

In the present disclosure, the AVNT function menus may be indexed based on the execution count of each AVNT function menus and the home screen menu may be reset based on the menus each having a small execution count, thereby providing the user with opportunities to utilize various AVNT function menus.

The present disclosure may actively provide various AVNT functions to the user, thereby enabling the user to use more AVNT functions and enabling the user to experience improved merchantability of the AVNT functions.

In addition, in the present disclosure, a computer-readable recording medium having recorded thereon a method of controlling a vehicular AVNT system may perform a process provided in the method of controlling the vehicular AVNT system according to the embodiment of the present disclosure.

The vehicle according to an embodiment of the present disclosure includes a communication device communicating with an external server or a user terminal and an AVNT system for displaying a home screen menu including a plurality of AVNT function menus. The AVNT system may collect the execution count of each AVNT function menu based on user input, index and store AVNT function menus based on the collected execution count of each AVNT function menu, reset a home screen menu based on high-order menus of the stored indices, and display the reset home screen menu.

The present disclosure provides technology for providing various function menus to users in order to solve a problem that users do not know about new functions and use only existing functions as the AVNT functions are diversified.

That is, in the present disclosure, main menus of the AVNT system may be indexed, the menu selection count of the user may be collected based on a certain cycle and stored as a DB, and the system may actively reconfigure menus each having a small execution count through interworking with the user terminal or an external center server after a certain time and provide the menus to the user.

In the vehicular AVNT system, the method of controlling the same and the vehicle including the same related to at least one embodiment of the present disclosure, it is possible to provide the user with opportunities to utilize various AVNT function menus, by indexing the AVNT function menus based on the execution counts of the AVNT function menus and resetting the home screen menu based on the menus each having a small execution count.

The present disclosure may actively provide various AVNT functions to the user, thereby enabling the user to use more AVNT functions and enabling the user to experience improved merchantability of the AVNT functions.

The disclosure can also be embodied as computer readable code on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and carrier waves (such as data transmission over the Internet).

The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A vehicular audio video navigation telematics (AVNT) system comprising:
an input device configured to receive user input for executing a plurality of AVNT function menus;
a storage device configured to index and store the plurality of AVNT function menus;
a display configured to display a home screen menu including the plurality of AVNT function menus; and
a controller configured to control the storage device and the display,
wherein the controller collects an execution count of each of the plurality of AVNT function menus based on the user input, indexes and stores the plurality of AVNT function menus in the storage device based on the collected execution count of each of the plurality of AVNT function menus, resets the home screen menu based on high-order menus of stored indices, and controls the display to display the reset home screen menu.

2. The vehicular AVNT system according to claim 1, wherein, when the plurality of AVNT function menus are indexed and stored in the storage device, the controller indexes and stores the plurality of AVNT function menus in an ascending order of accumulated execution counts.

3. The vehicular AVNT system according to claim 1, wherein, when the home screen menu is reset, the controller determines a number of the high-order menus to be selected from the stored indices, selects the high-order menus from the indices according to the determined number of high-order menus, and resets the home screen menu using the selected high-order menus.

4. The vehicular AVNT system according to claim 1, wherein, when the controller controls the display to display the reset home screen menu, if user input of selecting an AVNT function menu of the reset home screen menu is received, the controller controls the display to display a shortcut link for providing a web manual corresponding to the selected AVNT function menu.

5. The vehicular AVNT system according to claim 1, further comprising a communication device communicating with an external server,
wherein the controller collects the execution count of each of the plurality of AVNT function menus based on the user input, controls the communication device to transmit information on the collected execution count of each of the plurality of AVNT function menus to the external server, resets the home screen menu based on received index setting values when the index setting values of the home screen menu are received from the external server through the communication device, and controls the display to display the reset home screen menu.

6. The vehicular AVNT system according to claim 5, wherein, when information on the collected execution count of each of the plurality of AVNT function menus is transmitted to the external server, the controller transmits the information when a vehicle is turned off.

7. The vehicular AVNT system according to claim 5, wherein, when the home screen menu is reset, if a mode state of the vehicular AVNT system is a sleep mode state, the controller resets the home screen menu based on the received index setting values after the mode state is switched to a wakeup mode state.

8. The vehicular AVNT system according to claim 1, further comprising a communication device communicating with a user terminal,
wherein, when index setting values of the home screen menu are received from the user terminal through the communication device, the controller resets the home screen menu based on the received index setting values and controls the display to display the reset home screen menu.

9. The vehicular AVNT system according to claim 8, wherein, when the home screen menu is reset, if a mode state of the vehicular AVNT system is a sleep mode state, the controller resets the home screen menu based on the received index setting values after the mode state is switched to a wakeup mode state.

10. The vehicular AVNT system according to claim 8, wherein the user terminal generates the index setting values of the home screen menu based on user input and transmits the generated index setting values to the communication device.

11. A method of controlling a vehicular audio video navigation telematics (AVNT) system for displaying a home screen menu including a plurality of AVNT function menus, the method comprising steps of:
collecting an execution count of each of the plurality of AVNT function menus based on user input;
indexing and storing the plurality of AVNT function menus based on the collected execution count of each of the plurality of AVNT function menus;
resetting the home screen menu based on high-order menus of stored indices; and
displaying the reset home screen menu.

12. The method according to claim 11, wherein the step of indexing and storing the plurality of AVNT function menus includes indexing and storing the plurality of AVNT function menus in an ascending order of accumulated execution counts.

13. The method according to claim 11, wherein the step of resetting the home screen menu includes:
determining a number of high-order menus to be selected from the stored indices;
selecting high-order menus from the indices according to the determined number of high-order menus; and
resetting the home screen menu using the selected high-order menus.

14. The method according to claim 11, wherein the step of displaying the reset home screen menu includes, when user input of selecting an AVNT function menu of the reset home screen menu is received, displaying a shortcut link for providing a web manual corresponding to the selected AVNT function menu.

15. A method of controlling a vehicular audio video navigation telematics (AVNT) system configured to communicate with an external server and to display a home screen menu including a plurality of AVNT function menus, the method comprising steps of:
collecting an execution count of each of the plurality of AVNT function menus based on user input;
transmitting information on the collected execution count of each of the plurality of AVNT function menus to the external server;
receiving index setting values of the home screen menu from the external server;
resetting the home screen menu based on the received index setting values; and
displaying the reset home screen menu.

16. The method according to claim 15, wherein the step of resetting the home screen menu includes, if a mode state of the system is a sleep mode state, resetting the home screen menu based on the received index setting values after the system is switched to a wakeup mode state.

17. The method according to claim 15, wherein the step of displaying the reset home screen menu includes, if user input of selecting an AVNT function menu of the reset home screen menu is received, displaying a shortcut link for providing a web manual corresponding to the selected AVNT function menu.

18. A method of controlling a vehicular audio video navigation telematics (AVNT) system configured to communicate with a user terminal and to display a home screen menu including a plurality of AVNT function menus, the method comprising steps of:
receiving index setting values of the home screen menu from the user terminal;
resetting the home screen menu based on the received index setting values; and
displaying the reset home screen menu.

19. The method according to claim 18, wherein the step of resetting the home screen menu includes, if a mode state of the vehicular AVNT system is a sleep mode state, resetting the home screen menu based on the received index setting values after the mode state is switched to a wakeup mode state.

20. The method according to claim 18, wherein the step of displaying the reset home screen menu includes, if user input of selecting an AVNT function menu of the reset home screen menu is received, displaying a shortcut link for providing a web manual corresponding to the selected AVNT function menu.
